(19) United States
(12) Patent Application Publication
(10) Pub. No.: US 2026/0173219 A1
(43) Pub. Date: Jun. 18, 2026

(54) PLANAR HEATING ELEMENT

(71) Applicants: KURABE INDUSTRIAL CO., LTD., Hamamatsu-shi (JP); HONDA MOTOR CO., LTD., Tokyo (JP)

(72) Inventors: Tatsunori SUZUKI, Hamamatsu-shi (JP); Mikiji EMA, Hamamatsu-shi (JP); Tomoki OHSUGI, Hamamatsu-shi (JP); Ryoto MAENO, Hamamatsu-shi (JP); Yusuke SEKINE, Tokyo (JP); Eita SATO, Tokyo (JP)

(21) Appl. No.: 19/415,213

(22) Filed: Dec. 10, 2025

(30) Foreign Application Priority Data
Dec. 17, 2024 (JP) 2024-220716

(51) Int. Cl. H05B 3/84

(52) U.S. Cl. CPC H05B 3/84; H05B 2203/003; H05B 2203/007; H05B 2203/016

(57) ABSTRACT

In heating devices in related art, there is a problem that it is impossible to obtain such a heat radiation characteristic that the heat radiation is planarly uniform on the heating device side. A planar heating element according to an aspect of the present disclosure includes: a first heating element to which a first voltage output from a first control unit is applied; and a second heating element to which a second voltage output from a second control unit is applied, the second voltage being different from the first voltage, in which the first and second heating elements are incorporated into one sheet, and wiring-line widths and wiring line lengths of the first and second heating elements are set so that heating amounts per unit area thereof are equal to each other.

### INCORPORATION BY REFERENCE

This application is based upon and claims the benefit of priority from Japanese patent application No. 2024-220716, filed on Dec. 17, 2024, the disclosure of which is incorporated herein in its entirety by reference for all purposes.

### BACKGROUND

The present disclosure relates to a planar heating element, for example, a planar heating element which is formed as a sheet-like element and heats a certain surface.

In recent years, various types of heaters for removing fogging on a windscreen disposed in front of a camera mounted on an automobile have been proposed. An example of a technology related to such heaters is disclosed in U.S. Pat. No. 9,503,619.

A heating apparatus disclosed in U.S. Pat. No. 9,503,619 includes: an image recording device for recording image data; a carrier part of which the front side is disposed inside a window of a vehicle or in front of the inside thereof on the vehicle; a holder for holding the image recording device, coupled to the carrier part in such a manner that an optical recording axis of the image recording device points to the front region of the carrier part; and a heating device formed so that thermal radiation generated by the heating device is radiated toward a region in front of the carrier part so that the viewing region of the image recording device through the window of the vehicle is not blocked or impaired by heat, in which the heating device is formed so that the thermal radiation generated by the heating device is radiated toward the region in front of the carrier part so that the viewing region of the image recording device through the window of the vehicle is not blocked or impaired by fogging or icing, the heating device is configured to operate so that the two radiated power per unit area or per unit length for two different area parts or for different lengthwise parts are different from each other, regarding the radiated power, a different level of heat is radiated according to the radiating parr and/or the radiating direction, and the heating device is disposed on a baffle plate coupled to the carrier part, and is formed on the baffle plate in a strip shape, in a matrix, or in two-dimensional shape.

### SUMMARY

However, in the heating device disclosed in U.S. Pat. No. 9,503,619, there is a problem that it is impossible to obtain such a heat radiation characteristic that the heat radiation is planarly uniform on the heating device side.

A planar heating element according to an aspect of the present disclosure includes: a first heating element to which a first voltage output from a first control unit is applied; and a second heating element to which a second voltage output from a second control unit is applied, the second voltage being different from the first voltage, in which the first and second heating elements are incorporated into one sheet, and wiring-line widths and wiring line lengths of the first and second heating elements are set so that heating amounts per unit area thereof are equal to each other.

According to the planar heating element in accordance with the present disclosure, it is possible to provide a planar heating element having such a heat radiation characteristic that the heat radiation is planarly uniform on the planar heating element side while controlling two heating elements based on different applied voltages.

The above and other objects, features and advantages of the present disclosure will become more fully understood from the detailed description given hereinbelow and the accompanying drawings.

### BRIEF DESCRIPTION OF DRAWINGS

FIG. 1 is a block diagram of a heater system according to a first embodiment;

FIG. 2 is a schematic diagram of a planar heating element according to the first embodiment;

FIG. 3 is a diagram for explaining a region where the same heating power is set in the planar heating element according to the first embodiment;

FIG. 4 is a table for roughly explaining specifications of the planar heating element according to the first embodiment;

FIG. 5 is a cross-sectional diagram of a bracket according to the first embodiment;

FIG. 6 is a front view of the bracket according to the first embodiment;

FIG. 7 is a schematic diagram of a first example of a planar heating element according to a second embodiment;

FIG. 8 is a schematic diagram of a second example of a planar heating element according to the second embodiment; and

FIG. 9 is a schematic diagram of a third example of a planar heating element according to the second embodiment.

### DESCRIPTION OF EMBODIMENTS

To clarify the explanation, the following descriptions and drawings are omitted and simplified as appropriate. Note that the same reference numerals (or symbols) are assigned to the same elements throughout the drawings, and redundant descriptions thereof are omitted as appropriate.

### First Embodiment

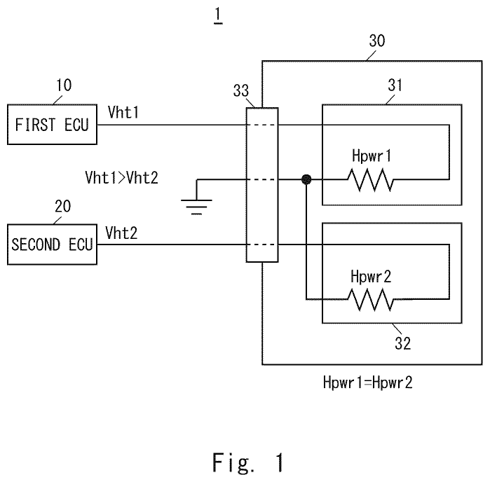

FIG. 1 is a block diagram of a heater system 1 according to a first embodiment. The heater system 1 according to the first embodiment is mounted to, for example, a camera bracket provided adjacent to the windshield of a vehicle, and heats a baffle plate incorporated into the bracket.

As shown in FIG. 1, the heater system 1 according to the first embodiment includes a first control unit (e.g., a first ECU (Electronic Control Unit) 10), a second control unit (e.g., a second ECU 20), and a planar heating element 30. Further, the planar heating element 30 includes a first heating element 31, a second heating element 32, and a connector 33.

The first ECU 10 outputs a first applied voltage Vht1 to the first heating element 31 and thereby controls the temperature of the first heating element 31. The second ECU 20 outputs a second applied voltage Vht2 to the second heating element 32 and thereby controls the temperature of the second heating element 32. The connector 33 includes terminals for connecting wiring lines connected to the first and second heating elements 31 and 32.

Note that although each of the first and second ECU 10 and 20 is shown as a processor for controlling the temperature of the planar heating element 30 in FIG. 1, it may have functions of controlling a camera (which is not shown in FIG. 1) and performing processing using an image acquired by the camera. Each of the first and second ECU 10 and 20 is, for example, a processor for performing various types of control including the control of the temperature of the planar heating element 30 by executing a program in an arithmetic unit provided therein.

In the heater system 1 according to the first embodiment, the first applied voltage Vht1 output from the first ECU 10 and the second applied voltage Vht2 output from the second ECU 20 are different from each other. Specifically, the first applied voltage Vht1 is higher than the second applied voltage Vht2. Further, the heater system 1 according to the first embodiment is designed so that the heat-radiation power per unit area (i.e., two heat-radiation power amounts per unit area) of the two heating elements, to which the different voltages are applied, become equal to each other. Further, in the heater system 1 according to the first embodiment, when the area of a first heating region where the first heating element 31 is provided and the area of a second heating region where the second heating element 32 is provided are equal to each other, first heat-radiation power Hpwr1, which is the heat-radiation power in the first heating region 41, and second heat-radiation power Hpwr2, which is the heat-radiation power in the second heating region, are equal to each other.

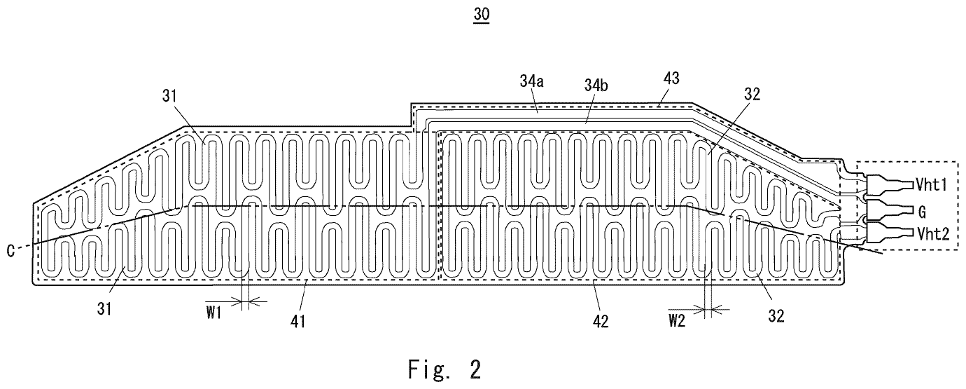

One of the features of the heater system 1 according to the first embodiment lies in the planar heating element 30, so that the planar heating element 30 will be described hereinafter in detail. FIG. 2 is a schematic diagram of the planar heating element 30 according to the first embodiment. The external shape of the planar heating element 30 is defined based on the shapes of the bracket to which it is mounted and the region to be heated, and the example shown in FIG. 2 is merely an example.

As shown in FIG. 2, the planar heating element 30 includes a first heating region 41, a second heating region 42, and a lead part 43. Further, in FIG. 2, regarding the connector 33, only the connecting part of the wire wiring lines to the planar heating element 30 (terminals to which the signs of the voltages to be applied are added) is shown. The connecting part between the planar heating element 30 and the wire wiring lines is, for example, covered by a heat-shrinkable tube.

The planar heating element 30 is formed by laminating two insulating sheets on both surfaces of planar wiring lines which will serve as heating elements. Each of the insulating sheets is, for example, a polyimide sheet having a thickness of about 0.1 mm. The external shape of the planar heating element 30 shown in FIG. 2 is the external shape of the polyimide sheets. Further, in the heater system 1 according to the first embodiment, the planar heating element 30 is formed by providing a planar wiring line in each of the first and second heating regions 41 and 42.

In the example shown in FIG. 2, the areas of the first and second heating regions 41 and 42 are equal to each other. Further, a planar wiring line which will serve as the first heating element 31 is provided in the first heating region 41, and another planar wiring line which will serve as the second heating element 32 is provided in the second heating region 42. Each of these planar wiring lines is composed of a band-like metal wiring line having a thickness of about 0.03 mm. These metal wiring lines may be, for example, mainly made of stainless steel (SUS: Steel Use Stainless) and/or copper.

Further, in the heater system 1 according to the first embodiment, the widths and lengths of the planar wiring lines of the first and second heating elements 31 and 32 are adjusted so that the heat-radiation power (i.e., two heat-radiation power amounts) of the two heating regions become equal to each other. Specifically, when the wiring-line width of the planar wiring line of the first heating element 31 is represented by W1 and the wiring-line width of the planar wiring line of the second heating element 32 is represented by W2, these wiring-line widths are adjusted so as to satisfy a relation W1<W2 because the voltage applied to the first heating element 31 is higher than that applied to the second heating element 32. By adjusting the wiring-line widths as described above, the resistance value R1 of the first heating element 31 becomes larger than the resistance value R2 of the second heating element 32. Further, based on the relationship between the applied voltage and the wiring-line resistance, the widths and lengths of the wiring lines of the first and second heating regions 41 and 42 are designed so that the heat-radiation power (i.e., the heat-radiation power amounts) in the first and second heating regions 41 and 42 become equal to each other in the example shown in FIG. 2.

Further, in the example shown in FIG. 2, the wiring lines are folded back a number of times in order to obtain wiring-line lengths that satisfy the heat-radiation power required for the first and second heating elements 31 and 32. In particular, in the example shown in FIG. 2, a line that equally divides the first and second heating elements 31 and 32 in a second direction (vertical direction in FIG. 2) orthogonal to a first direction (horizontal direction in FIG. 2) in which the first and second heating elements 31 and 32 are arranged, and extends in the first direction is defined as a heating-region center line C. Further, in the example shown in FIG. 2, a first region and a second region are defined on the upper and lower sides, respectively, of the heating-region center line C across the heating-region center line C. Further, a folded wiring line (i.e., a wiring line folded back a number of times) is disposed in each of the first and second regions. It should be noted that in the example shown in FIG. 2, a first planar wiring line having a folded pattern is formed in the first region; a second planar wiring line having a folded pattern is formed in the second region; and planar wiring line sections, each of which is folded so as to cross the heating-region center line C, are alternately arranged in the first and second regions. As described above, in the case where the folded pattern wiring lines are divided into a plurality of regions, it is possible to dispose parts of wiling line patters even on the boundary between the regions by disposing parts of the wiring line patterns which are originally disposed on one of the divided regions on the other divided region, and thereby to increase the bending strength of the sheet. Further, by adopting such a wiring line pattern, it is possible to eliminate the region where there is no heating element near the heating-region center line C, and thereby to improve the in-plane uniformity of the heating amount. Note that it is sufficient if the wiring line pattern that crosses the heating-region center line C is provided in at least one of the first and second heating elements 31 and 32.

Further, as shown in FIG. 2, the planar heating element 30 includes the lead part 43 in which a lead wiring line 34a and a lead wiring line 34b, each of which is a planar wiring line similar to those in the first and second heating regions 41 and 42 and serves as a power supply path to the first heating region 41, are arranged. These lead wiring lines 34a and 34b provided in the lead part 43 may also generate heat, but their heating amounts should be as small as possible, so that the lead wiring lines 34a and 34b are designed with wiring-line widths larger than those of the first heating element 31. In the form shown in FIG. 2, the lead part 43 is provided in a region adjacent to the second heating region 42 which is different from the first heating region 41 to which the power is supplied through the lead part 43.

Further, in the example shown in FIG. 2, a common ground terminal G is used as the ground terminal G of the first heating element 31 and the ground terminal G of the second heating element 32. By using the common ground terminal G for both the first and second heating elements 31 and 32 as described above, the size of the part for connecting the planar heating element 30 to the lead lines can be reduced. Further, it is possible to reduce the number of parts and to reduce the man-hours of the manufacturing by reducing the number of parts to be assembled.

Note that the lead wiring lines 34a and 34b can be wire wiring lines. By using wire wiring lines, the amount of heat generated in the lead part 43 can be further reduced.

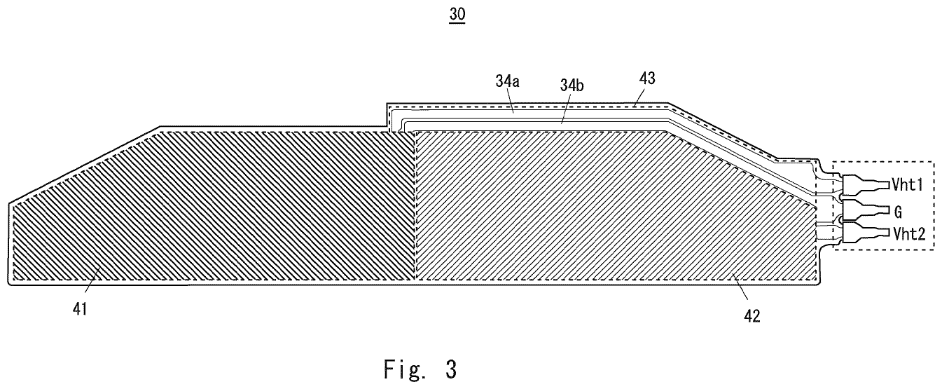

In the heater system 1 according to the first embodiment, the areas and the heat amounts of the first and second heating regions 41 and 42 are set so as to be equal to each other. Therefore, FIG. 3 shows a diagram for explaining regions in which the heating power are set so as to be equal to each other in the planar heating element according to the first embodiment. As shown in FIG. 3, in the heater system 1 according to the first embodiment, the areas of the first and second heating regions 41 and 42 are set so as to be equal to each other, and the heating power of the first and second heating regions 41 and 42 are set so as to be equal to each other. Note that as shown in FIG. 3, the lead part 43 is not included in the heating regions.

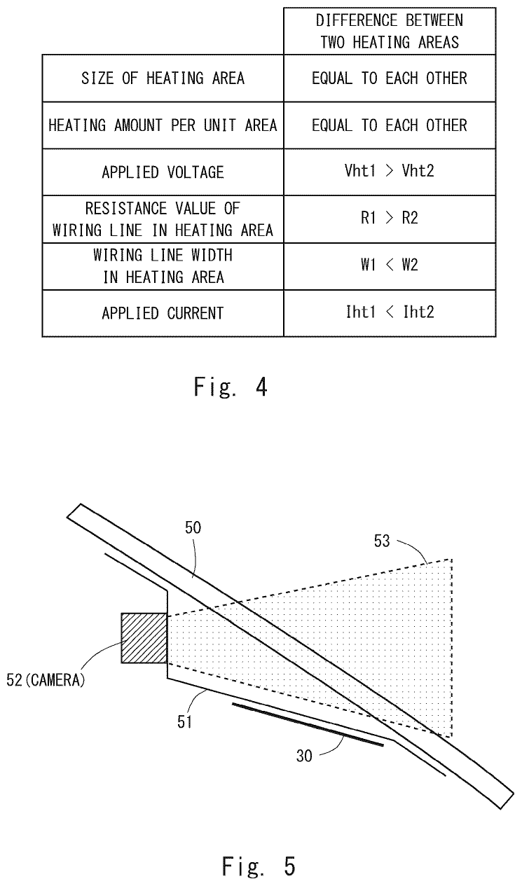

Specifications of the planar heating element 30 will be roughly described hereinafter with reference to a table. FIG. 4 is a table for roughly explaining specifications of the planar heating element 30 according to the first embodiment. In FIG. 4, differences in design specifications for the two heating regions, i.e., the first and second heating regions 41 and 42, are shown in a table format. As shown in FIG. 4, in the planar heating element 30, the design values of the areas of the first and second heating regions 41 and 42 are equal to each other. Further, the design values of the heat-radiation power per unit area of the first and second heating regions 41 and 42 are also equal to each other. Meanwhile, regarding the voltages applied to the first and second heating elements 31 and 32, the first applied voltage Vht1 applied to the first heating element 31 is higher than the second applied voltage Vht2 applied to the second heating element 32. These voltages are determined by the specifications of the first and second ECU 10 and 20.

Further, in order to satisfy the above-described three specifications, in the planar heating element 30, the resistance value R1 of the first heating element 31 provided in the first heating region 41 is made larger than the resistance value R2 of the second heating element 32 provided in the second heating region 42. Further, in order to satisfy this characteristic in regard to the resistance value, the wiring-line width W1 of the first heating element 31 provided in the first heating region 41 is made smaller than the wiring-line width W2 of the second heating element 32 provided in the second heating region 42. Further, an applied current Iht1 flowing through the first heating element 31 is smaller than an applied current Iht2 flowing through the second heating element 32 due to the differences of the applied voltage, the resistance value, and the wiring-line width. Note that it is also possible to make the resistance value R1 larger than the resistance value R2 by making the wiring line length L1 of the first heating element 31 longer than the wiring line length L2 of the second heating element 32 while making the wiring-line widths W1 and W2 equal to each other.

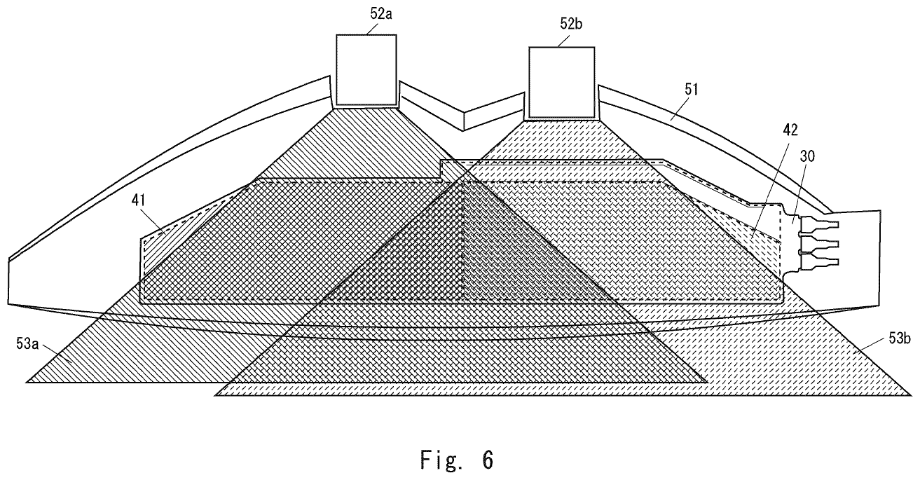

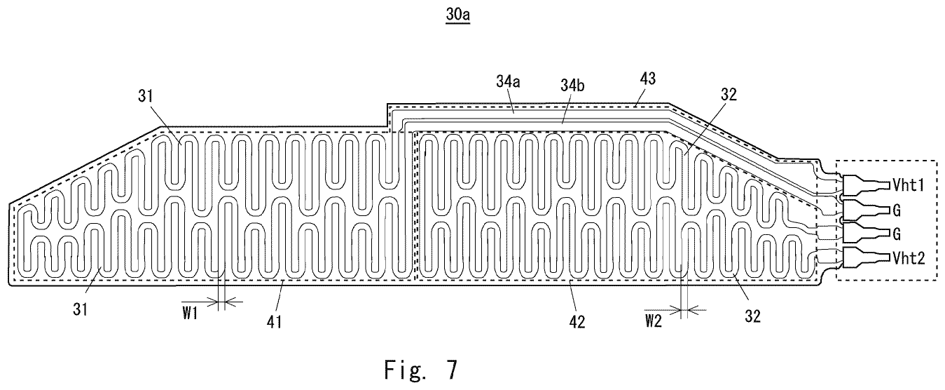

Next, a method for mounting the planar heating element 30 to a bracket will be described. FIG. 5 shows a cross-sectional diagram of a bracket according to the first embodiment. Note that in FIG. 6, the left side of the drawing is the inside of the vehicle, and the right side of the drawing is the outside of the vehicle.

As shown in FIG. 6, cameras 52 are mounted to the bracket 51 to which the planar heating element 30 is mounted. Further, the bracket 51 is mounted to a windscreen 50 from the inside of the vehicle in such a manner that the shooting ranges 53 of the cameras 52 point to the outside of the vehicle. The planar heating element 30 is mounted to the surface of the bracket 51 on the inside of the vehicle. Note that the surface of the bracket 51 that faces the shooting ranges 53 is a baffle plate which is subjected to an anti-reflection process in advance or has an anti-reflection structure.

Next, FIG. 6 shows a front view of the bracket according to the first embodiment. The front view shown in FIG. 6 shows the windscreen 50 as viewed from the outside of the vehicle. Further, in FIG. 6, the planar heating element 30 mounted to the surface of the bracket 51 on the inside of the vehicle is also shown in order to show its position, but in reality, the planar heating element 30 cannot be visually recognized from the front side.

As shown in FIG. 6, two cameras, i.e., a first camera (camera 52a) and a second camera (camera 52b), are mounted to the bracket 51. Further, since the cameras 52a and 52b are mounted at different positions, there is a difference between the shooting ranges of these two cameras. In FIG. 6, the shooting range of the camera 52a is shown as a shooting range 53a, and the shooting range of the camera 52b is shown as a shooting range 53b. Further, the first heating element 31 of the planar heating element 30 mainly heats the region corresponding to the shooting range 53a of the first camera (e.g., the camera 52a) and also heats a part of the region corresponding to the shooting range 53b of the second camera (e.g., the camera 52b). Further, the second heating element 32 of the planar heating element 30 mainly heats the region corresponding to the shooting range 53b of the camera 52b and also heats a part of the region corresponding to the shooting range 53b of the camera 52a.

As described above, by mounting the planar heating element 30 to the bracket 51, heat generated in the planar heating element 30 is transmitted to the windscreen 50, so that fogging on the windscreen 50 is removed or prevented. Note that although two cameras are used in FIG. 6, the number of cameras may be two or more (e.g., three or four).

As described above, by using the planar heating element 30 according to the first embodiment, a plurality of heating elements controlled by different applied voltages can be controlled in such a manner that they output heat-radiation power (i.e., the heat-radiation power amounts) equal to each other. In particular, when the ECUs that control the first and second heating elements 31 and 32, respectively, have voltage output characteristics different from each other, it is difficult to control the two heating elements so as to output heat-radiation power equal to each other. However, in the planar heating element 30 according to the first embodiment, since the resistance values of the first and second heating elements 31 and 32 are values different from each other and are designed so as to output heat-radiation power equal to each other, it is easy to control them so as to output heat-radiation power equal to each other.

Further, in the planar heating element 30 according to the first embodiment, the heat-radiation power per unit area of the first and second heating regions 41 and 42 are made equal to each other, and their areas are made equal to each other. Therefore, in the planar heating element 30, the heat-radiation power of the first and second heating regions 41 and 42 can be made equal to each other.

Note that U.S. Pat. No. 9,503,619 neither discloses nor suggests any matter for the feature that the heat radiation characteristics become planarly uniform on the planar heating element side for different applied voltages (i.e., even when the applied voltages are different from each other) as described above.

### Second Embodiment

In a second embodiment, a plurality of other forms of the planar heating element 30 will be described. Note that in the description of the second embodiment, the same components as those in the first embodiment are assigned the same reference numerals (or symbols) as those in the first embodiment, and descriptions thereof are omitted.

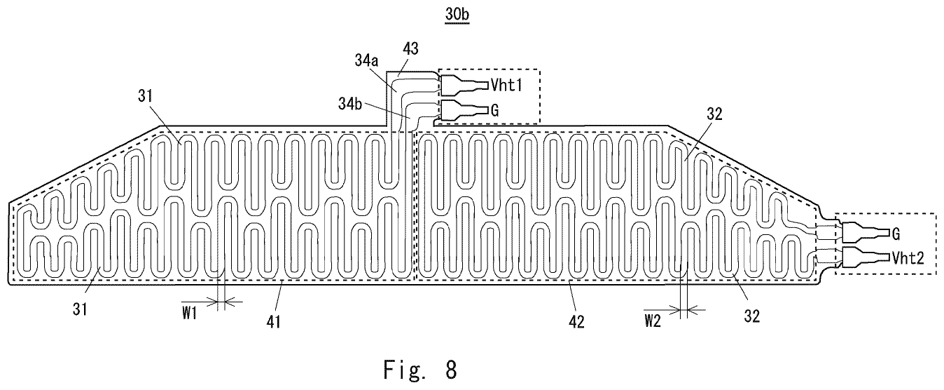

Firstly, FIG. 7 shows a schematic diagram of a planar heating element 30a as a first example of a planar heating element according to the second embodiment. In the example shown in FIG. 7, the ground wiring line G of the first heating element 31 and the ground wiring line G of the second heating element 32 are terminals independent of each other.

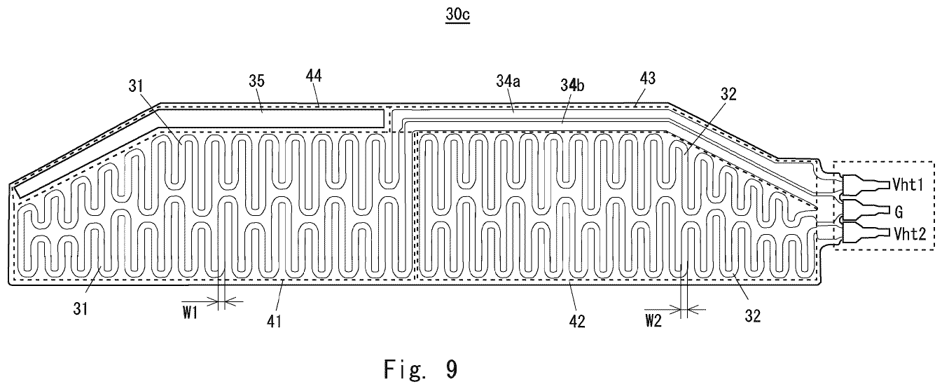

FIG. 8 shows a schematic diagram of a planar heating element 30b as a second example of a planar heating element according to the second embodiment. In the example shown in FIG. 8, in order to reduce the size of the lead part 43 as much as possible, a connection terminal of a wire wiring line for supplying power to the first heating element 31 and a connection terminal for supplying ground voltage thereto are provided at positions as close as possible to the first heating region 41. In the example shown in FIG. 8, the lead wiring line 34a and the lead wiring line 34b, which are planar wiring lines, are extremely short as compared with those in the other examples. Even in this configuration, the lead wiring line provided for the first heating element 31 can be changed to a wire wiring line.

FIG. 9 is a schematic diagram of a planar heating element 30c as a third example of a planar heating element according to the second embodiment. In the example shown in FIG. 9, a reinforcing part 44 having a shape axially-symmetrical to that of the lead part 43 is provided in a region adjacent to the first heating region 41. A floating wiring line 35, which is supplied with no voltage and hence has a floating potential, is provided in the reinforcing part 44. The floating wiring line 35 is formed of the same material as that of the first and second heating elements 31 and 32, such as SUS. The rigidity of the planar heating element 30c can be increased by providing this reinforcing part 44.

From the above explanation, it can be understood that various modified examples such as a modified connection between the planar heating element 30 and the wire wiring line, a modified configuration of the lead part 43, and an addition of a reinforcing part 44 are conceivable. Meanwhile, in all the planar heating elements 30a to 30c according to the second embodiment, the configurations of the first and second heating elements 31 and 32, which are incorporated into the first and second heating regions 41 and 42, are identical to each other. That is, as long as the configurations of the first and second heating regions 41 and 42 are maintained, it is possible to control a plurality of heating elements controlled by different applied voltages so as to output heat-radiation power equal to each other.

The first and second embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A planar heating element comprising:
a first heating element to which a first voltage output from a first control unit is applied; and
a second heating element to which a second voltage output from a second control unit is applied, the second voltage being different from the first voltage,
wherein the first and second heating elements are incorporated into one sheet, and wiring-line widths and wiring line lengths of the first and second heating elements are set so that heating amounts per unit area thereof are equal to each other.

2. The planar heating element according to claim 1, wherein:
the first heating element is provided so as to correspond to a first heating region;
the second heating element is provided so as to correspond to a second heating region, and
areas of the first and second heating regions are set so as to be equal to each other.

3. The planar heating element according to claim 2, wherein a first lead wiring line configured to supply power to the first heating element is provided in a region different from the first heating region and disposed along the second heating region.

4. The planar heating element according to claim 3, wherein each of the first heating element, the second heating element, and the first lead wiring line is formed by a planar wiring line, and a wiring-line width of the first lead wiring line is larger than that of the first heating element.

5. The planar heating element according to claim 2, further comprising a floating wiring line region provided in a region adjacent to the first heating region, an independent floating wiring line being provided in the floating wiring line region.

6. The planar heating element according to claim 1, wherein each of the first and second heating elements is formed by a planar wiring line.

7. The planar heating element according to claim 1, wherein an insulating sheet is laminated on the first and second heating elements.

8. The planar heating element according to claim 1, wherein:
the first heating element mainly heats a region corresponding to a shooting range of a first camera and also heats a part of a region corresponding to a shooting range of a second camera, and
the second heating element mainly heats a region corresponding to the shooting range of the second camera and also heats a part of the region corresponding to the shooting range of the first camera.

9. The planar heating element according to claim 8, wherein the first and second heating elements are mounted on a rear surface side of a bracket to which the first and second cameras are mounted, the rear surface side of the bracket being opposed to a baffle plate facing outside of a vehicle, and the outside of the vehicle being photographing regions of the first and second cameras.

10. The planar heating element according to claim 1, wherein a first ground terminal configured to connect the first heating element to a ground and a second ground terminal configured to connect the second heating element to a ground are provided as one common terminal.

11. The planar heating element according to claim 1, wherein:
a line that equally divides the first and second heating elements in a second direction orthogonal to a first direction in which the first and second heating elements are arranged, and extends in the first direction is defined as a heating-region center line,
a first region and a second region are defined on both sides of the heating-region center line in at least one of the first and second heating elements,
a first planar wiring line having a folded pattern is formed in the first region,
a second planar wiring line having a folded pattern is formed in the second region, and
planar wiring line sections, each of which is folded so as to cross the heating-region center line, are alternately arranged in the first and second regions.
